(19) United States
(12) Patent Application Publication
(10) Pub. No.: US 2005/0129252 A1
(43) Pub. Date: Jun. 16, 2005

(54) Audio presentations based on environmental context and user preferences

(75) Inventors: Douglas Heintzman, Pleasantville, NY (US); Richard S. Schwerdtfeger, Round Rock, TX (US); Lawrence F. Weiss, Round Rock, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/734,774

(22) Filed: Dec. 12, 2003

(51) Int. Cl. H04R 29/00

(52) U.S. Cl. 381/58

(57) ABSTRACT

The present invention provides a method for audio presentations based on environmental context and user preferences. The method includes receiving data indicative of acoustic conditions proximate to an audio presentation device, receiving data associated with at least one audio profile, and determining acoustic data to be provided based on at least a portion of the received data indicative of acoustic conditions proximate to the audio presentation device and at least a portion of the data associated with the at least one audio profile.

### BACKGROUND OF THE INVENTION

1. Field of the Invention

This invention relates generally to audio presentation systems, and, more particularly, to audio presentations based on environmental context and user preferences.

2. Description of the Related Art

The increase in utility and availability of various information technology services has led to a corresponding proliferation of devices for accessing these services via, e.g., wired and wireless networks. For example, desktop computers, laptop computers, personal data assistants, cell phones, navigation systems, MP3 players, satellite radios, and the like may be coupled to a variety of information technology services via wired and/or wireless networks such as the World Wide Web, wide area networks, local area networks, and the like. Although these devices may share the same networks, not all the devices, or even all models or versions of the same device, are capable of providing information in the same format.

Consequently, the information technology industry is working toward being able to provide information to a particular device in a format that is appropriate to the device. In one approach, a profile indicating one or more device preferences may be provided to a server. The server may then use the profile to transform information to a format appropriate for the device. For example, a Composite Capabilities/Preferences Profile (often referred to as a CC/PP) may be used to pass information regarding the capabilities and/or preferences of a particular device. When the device requests information from a server, the server, or an intermediary, may access the profile to determine the appropriate format for information that may be transmitted to the device.

Audio presentation of information poses a unique set of challenges for these so-called on-demand solutions. For example, pervasive devices such as laptop computers, personal data assistants, cell phones, navigation systems, MP3 players may provide an acoustic signal to a user. The ability of the user to hear the acoustic signal change as the user moves from one environment to another. For example, the intensity and/or pitch of ambient noise may change as a user carries the pervasive device from one context to another. Non-pervasive devices may also provide an acoustic signal. For example, most desktop computers are able to play music and many include voice recognition software that may provide an audio playback function. The ability of the user to hear the acoustic signal provided by non-pervasive devices may also be affected by changing environmental conditions, such as ambient noise caused by conversations, construction, traffic, appliances, low flying airplanes, other audio presentation devices, and the like. The ambient noise may be broad spectrum or confined to a narrow range of frequencies.

The user's ability to hear an acoustic signal may also be affected by deficiencies in the user's hearing. For example, many people experience a hearing deficit in a range of frequencies, which may make it difficult for them to hear an acoustic signal in that frequency range, particularly if the ambient noise level in that frequency range is high. However, these same people may experience little or no degradation of their hearing in other frequency ranges, even at comparatively high levels of ambient noise. As users age, their hearing deficit in a particular range may increase, the range of frequencies in which the deficit is noticeable may widen, and, in some cases, the user may become deaf at all frequencies.

Virtually all audio devices include a volume knob that allows the user to raise or lower the intensity of the acoustic signal, and changing the volume may, in part, compensate for increasing ambient noise levels. In extreme cases, such as when the user is watching a television in a noisy bar or when the user is deaf, spoken text provided by the audio presentation device may be close captioned. However, conventional volume controls do not allow the user to compensate for ambient noise and/or hearing deficits in a particular frequency range, and close captioning does not provide a satisfactory method of interpreting abstract acoustic signals that are not readily converted into text. Moreover, conventional volume controls and close captioning require the user to determine when an adjustment, or close captioning, is needed and then manually perform the adjustment or initiate close captioning.

Some audio devices, such as a television, may also include a mute button that provides a signal to the television indicating that the audio signal provided by the television should be muted. When the mute button is pressed, the television may provide close captioning of a portion of the audio signal. For example, text corresponding to spoken words may be displayed on the television screen. However, conventional muting and/or close captioning features are not sensitive to the acoustic environment, and so the user must activate the mute and/or close caption functions of conventional audio devices when, e.g., ambient noise levels become too high for the user to hear the audio portion of the television broadcast.

The present invention is directed to addressing, or at least reducing, the effects of, one or more of the problems set forth above.

### SUMMARY OF THE INVENTION

In one aspect of the instant invention, a method is provided for audio presentations based on environmental context and user preferences. The method includes receiving data indicative of acoustic conditions proximate to an audio presentation device, receiving data associated with at least one audio profile, and determining acoustic data to be provided based on at least a portion of the received data indicative of acoustic conditions proximate to the audio presentation device and at least a portion of the data associated with the at least one audio profile. An apparatus and a system for performing the method are also provided.

### BRIEF DESCRIPTION OF THE DRAWINGS

The invention may be understood by reference to the following description taken in conjunction with the accompanying drawings, in which like reference numerals identify like elements, and in which:

FIG. 1 illustrated one embodiment of a system including various devices for providing an acoustic signal that are communicatively coupled to a server.

FIG. 2 conceptually illustrates one embodiment of a system including an audio presentation device, such as the devices shown in FIG. 1.

FIG. 3 conceptually illustrates one embodiment of a method of providing audio presentations based upon environmental context and user preferences.

FIG. 4 shows a stylized block diagram of a system that may be implemented in the system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

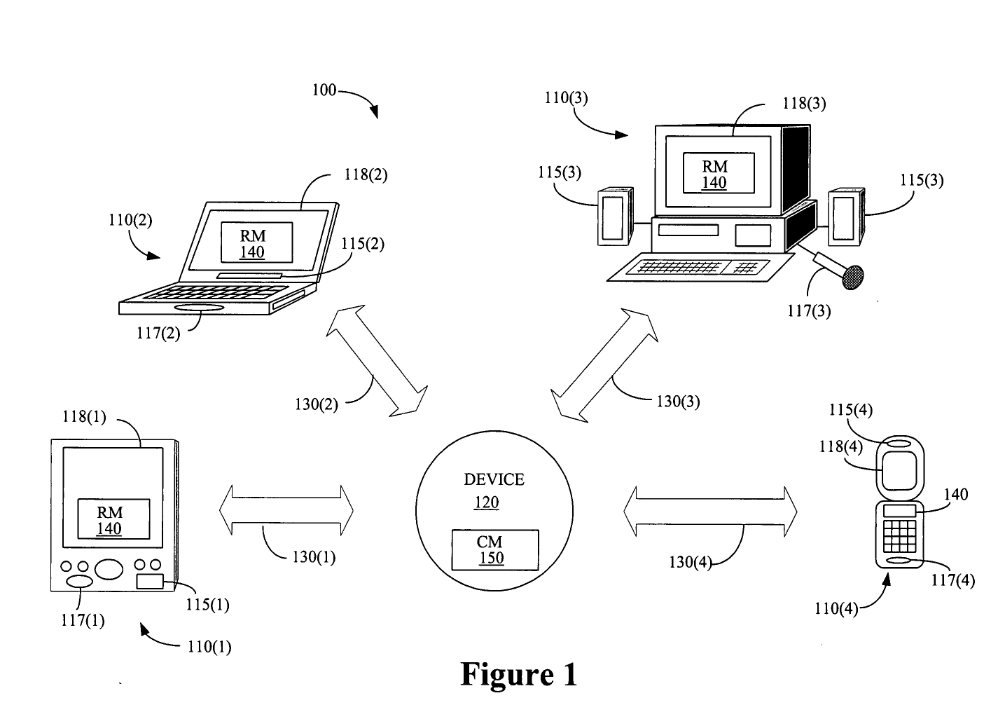

FIG. 1 shows a system 100 including various devices 110(1-4) for providing audio information and, in particular, acoustic data including acoustic signals, close captioning, and other representations of sound. In various alternative embodiments, the devices 110(1-4) may include one or more pervasive and/or non-pervasive devices. For example, the devices 110(1-4) may include a personal data assistant 110(1), a laptop computer 110(2), a desktop computer 110(3), a cellular telephone 110(4), and the like. However, persons of ordinary skill in the art will appreciate that, in alternative embodiments, the devices 110 (1-4) may include other devices capable of providing audio information, such as MP3 players, radios, televisions, and the like. Moreover, any desirable number and combination of the devices 110(1-4) may be included in the system 100.

Each of the devices 110(1-4) includes an audio presentation device 115(1-4) that is capable of providing an acoustic signal. For example, the audio presentation devices 115(1-4) may be analog speakers, solid state speakers, headphones, and the like. In one embodiment, each of the devices 110(1-4) may also include an acoustic detector 117(1-4) that is capable of receiving an acoustic signal and a display device 118(1-4) that is capable of displaying visual representations of acoustic data. For example, the acoustic detector 117(1-4) may be one of many known types of microphones and the like, and the display devices 118(1-4) may be flat panel displays capable of displaying close captioning, visualizations, music scores, and other visual representations of sound.

The various audio presentation devices 115(1-4) may have different audio presentation capabilities. For example, the audio presentation devices 115(1-4) may be capable of providing acoustic signals in a specific range of frequencies, in a specific range of volumes, and the like. The size and/or sound quality provided by the audio presentation devices 115(1-4) may also vary. For example, the audio presentation devices 115(2-3) coupled to the desktop computer 110(3) may be substantially larger and be capable of providing more accurate frequency response than the audio presentation devices 115(1), 115(4) included in the personal data assistant 110(1) and the cellular telephone 110(4), respectively. In one embodiment, the aforementioned capabilities and characteristics of the audio presentation devices 115(1-4) may be stored in an audio profile. However, in alternative embodiments, the capabilities and characteristics of the audio presentation devices 115(1-4) may be stored in a separate device profile.

The display devices 118(1-4) may be capable of providing acoustic data in a variety of forms. In one embodiment, the display devices 118(1-4) may provide close captioning of spoken text. In another embodiment, the display devices 11 8(1-4) may provide animated visualizations of music or other acoustic signals. In yet another embodiment, the display devices 118(1-4) may provide a musical score corresponding to the acoustic data. In one embodiment, the aforementioned capabilities and characteristics of the display devices 118(1-4) may be stored in an audio profile. However, in alternative embodiments, the capabilities and characteristics of the display devices 118(1-4) may be stored in a separate device profile.

The devices 110(1-4) are communicatively coupled to a processor-based device 120 by links 130(1-4). In various alternative embodiments, the links 130(1-4) may be any desirable combination of wired and/or wireless links 130(1-4). For example, the personal data assistant 110(1) may be communicatively coupled to the processor-based device 120 by an infrared link 130(1). For another example, the laptop computer 110(2) may be communicatively coupled to the processor-based device 120 by a wireless local area network (LAN) link 130(2). As yet another example, the desktop computer 110(3) may be communicatively coupled to the processor-based device 120 by wired LAN connection 130(3), such as an Ethernet connection. As yet another example, the cellular telephone 110(4) may be communicatively coupled to the processor-based device 120 by a cellular network link 130(4). However, in alternative embodiments, any desirable mode of communicatively coupling the devices 110(1-4) and the processor-based device 120, including radiofrequency links, satellite links, and the like, may be used.

The processor-based device 120 is capable of providing one or more signals to the devices 110(1-4). In one embodiment, the processor-based device 120 is a network server that is capable of transmitting information to, and receiving information from, the devices 110(1-4). However, the present invention is not limited to network servers. In alternative embodiments, the processor-based device 120 may be a transcoder, a network hub, a network switch, and the like. Moreover, the processor-based device 120 may not be external to one or more of the devices 110(1-4). For example, the processor-based device 120 may be a processor (not shown) included in one or more of the devices 110(1-4) to perform the desired features. In another embodiment, some aspects of the processor-based device 120 may be implemented in the devices 110(1-4) while other aspects of the processor-based device 120 may be implemented elsewhere, external to the devices 110(1-4).

In one embodiment, the devices 110(1-4) may include a remote module 140, which may receive data indicative of acoustic conditions proximate to the devices 110(1-4), respectively. For example, the acoustic detectors 117(1-4) may provide a signal indicative of acoustic noise proximate to the devices 110(1-4) to the remote module 140. The remote module 140 may also receive data associated with at least one audio profile containing information indicative of the capabilities and characteristics of the devices 110(1-4), 115(1-4), 117(1-4), 118(1-4) as well as the preferences and/or capabilities of the user. The remote module 140 may determine an acoustic signal to be provided by the device 110(1-4) on, for example, the audio presentation devices 115(1-4), respectively, based on at least a portion of the received data and the received audio profile.

The processor-based device 120 may, in one embodiment, include a controller module 150, which may receive data indicative of acoustic conditions proximate to the devices 110(1-4), respectively. The controller module 150 may also receive data associated with at least one audio profile and determine an acoustic signal to be provided by the device 110(1-4) on, for example, the audio presentation devices 115(1-4), respectively, based on at least a portion of the received data and the received audio profile. The various modules 140, 150 illustrated in FIG. 1 are implemented in software, although in other implementations these modules may also be implemented in hardware or a combination of hardware and software.

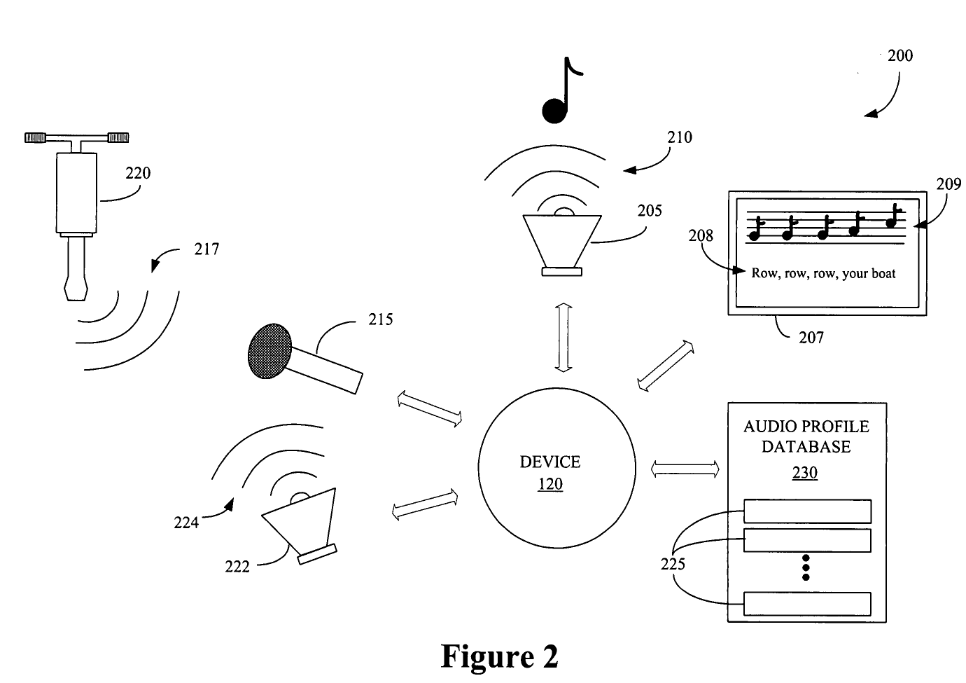

FIG. 2 conceptually illustrates a system 200 including an audio presentation device 205, such as the audio presentation devices 115(1-4) that may be used in the devices 110(1-4) shown in FIG. 1. In the illustrated embodiment of FIG. 2, the features of the processor-based device 120 may be integrated within the system 200 or, alternatively, may be implemented external to the system 200. The audio presentation device 205 is communicatively coupled to the processor-based device 120, which may provide a signal that the audio presentation device 205 may use to provide an acoustic signal 210. Alternatively, the processor-based device 120 may provide a signal that a display device 207 may use to provide close captioning 208 of the acoustic signal 210, or some other representation of the acoustic data such a musical score 209. As discussed above, portions of the processor-based device 120 may be included in the device housing the audio presentation device 205 or the display device 207, as well as external to the device housing the audio presentation device 205 and the display device 207.

The processor-based device 120 is communicatively coupled to an acoustic detector 215 capable of acquiring data indicative of acoustic conditions proximate to the audio presentation device 205. For example, the acoustic detector 215 may be capable of measuring the decibel level of ambient noise 217 from, for example, a jackhammer 220. The acoustic detector 215 may also be capable of acquiring data indicative of other acoustic conditions proximate to the audio presentation device 205 including, but not limited to, the spectrum of the ambient noise 217, variability of the ambient noise 217, and the like. For example, the processor-based device 120 may perform a frequency analysis of the ambient noise to determine the spectrum of the ambient noise. The acoustic detector 215 may provide the acquired data indicative of the acoustic conditions proximate to the audio presentation device 205 to the processor-based device 120. In various alternative embodiments, the acoustic detector 215 may be a microphone, and the like.

In one embodiment, an audio presentation device 222 may also be communicatively coupled to the processor-based device 120. The audio presentation device 222 may provide an acoustic test signal 224. For example, the audio presentation device 222 may provide a white noise test signal 224 having a known decibel level. Alternatively, the audio presentation device 222 may provide an acoustic test signal 224 having a predetermined range of frequencies and a known decibel level. For example, the acoustic test signal 224 may be in a frequency range below 440 Hz or in a frequency range above 440 Hz. Although the audio presentation device 222 is depicted in FIG. 2 as being distinct from the audio presentation device 205, the present invention is not so limited. In alternative embodiments, the audio presentation device 222 may not be present and the audio presentation device 205 may also provide the acoustic test signal 224.

The system 200, in one embodiment, may have a plurality of users. In the illustrated embodiment, the plurality of users may each have an associated audio profile 225 stored in a database 230, which may be located at any desired location, including on the processor-based device 120 or another device. For example, the database 230 may be stored in a location remote to the processor-based device 120. In one embodiment, the audio profile 225 includes a user profile and a device profile. The user and device profiles may, in various alternative embodiments, be stored in any desirable location. In particular, the user and device profiles may be stored in different locations and/or different databases.

The processor-based device 120 may access the one or more audio profiles 225 that contain information that can be used by the processor-based device 120 to provide acoustic data to the audio presentation device 205 and/or the display device 207 in a manner desired by the user. For example, the audio profiles 225 may be Composite Capabilities/Preferences Profiles that may be stored at any desirable location. In one alternative embodiment, the audio profiles 225 may be an extended version of a Learner Profile. A conventional Learner Profile is defined by the IMS Learner Information Package (LIP) specification version 1.0.

In one embodiment, the audio profiles 225 include information about the capabilities of the particular device being used by the user, such as the audio presentation devices 115(1-4) and the display devices 118(1-4) shown in FIG. 1. For example, the audio profiles 225 may indicate that the display device 207 is capable of displaying close captioning. For another example, the audio profiles 225 may indicate that the audio presentation device 205 may receive analog or digital signals, the physical dimensions of the audio presentation device 205, the frequency response of the audio presentation device 205, and other parameters of the audio presentation device 205. In addition, the audio profiles 225 may indicate the preferred mode of operation of the audio presentation device 205. For example, the audio profiles 225 may indicate that a default mode of operation of the audio presentation device 205 preferentially provides an acoustic signal in a frequency range corresponding to a treble range at a volume level of 11.

The audio profiles 225 may also include information specific to one or more users. In one embodiment, the user information may include the user's preferences. For example, a first audio profile 225 may include data indicating that a first user prefers spoken text to be provided as an acoustic signal corresponding to the frequency range of a typical female voice. In contrast, a second audio profile 225 may include data indicating that a second user prefers spoken text to be provided as an acoustic signal corresponding to the frequency range of a typical male voice. Furthermore, a third audio profile 225 may include data indicating that a third user prefers spoken text to be provided as close captioned text.

The audio profiles 225 may also include information about the user's capabilities. In particular, the audio profiles 225 may include information indicating any limitations in the user's audio capabilities that may impact the user's ability to hear acoustic signals provided by the audio presentation device 205. For example, a first audio profile 225 may indicate that a first user has a partial hearing deficit in a range of frequencies below about 440 Hz, but substantially no hearing deficit above a frequency of about 440 Hz. A second user, however, may have an associated audio profile 225 indicating that the second user has a partial hearing deficit in a range of frequencies above about 440 Hz, but substantially no hearing deficit below a frequency of about 440 Hz. In one embodiment, the audio profiles 225 may be edited or modified by the user. In one embodiment, the user may establish the user profile indicating the user's capabilities by providing the relevant information. Alternatively, a doctor may test the user's hearing and form the user profile based on the test results, or an automated testing system may be used to establish the user profile.

Although the embodiment of the audio profile 225 shown in FIG. 2 includes information associated with both the user and the audio presentation device 205, the present invention is not so limited. In alternative embodiments, portions of the audio profile 225 corresponding to the user's preferences and/or capabilities, i.e. a user profile, and the characteristics and/or capabilities of the audio presentation device 205, i.e. a device profile, may be separate entities. For example, the audio profile database 230 may include one set of entries associated with the portion of the audio profile 225 corresponding to the user's preferences and/or capabilities, and a second set of entries corresponding to the portion of the audio profile 225 associated with the characteristics and/or capabilities of the audio presentation device 205.

As the conditions proximate to the audio presentation device 205 change, the provided acoustic signal may become more difficult to hear. For example, if a user is listening to a recorded voice using a personal data assistant while walking from a quiet office into a noisy street, the ambient noise in the street may obscure the acoustic signal provided by the audio presentation device 205 of the personal data assistant. Alternatively, the user of the audio presentation device 205 may change, making the current audio presentation preferences undesirable. For example, a first user may log off a desktop computer, which may be providing an acoustic signal using the first user's preferences, e.g., an acoustic signal that is enhanced at frequencies above about 440 Hz to compensate for a partial hearing deficit at frequencies below about 440 Hz, as indicated in a first audio profile 225. A second user requiring or preferring an acoustic signal that is enhanced at frequencies below about 440 Hz to compensate for a partial hearing deficit at frequencies above about 440 Hz, as indicated in a second audio profile 225, may then log on to the desktop computer.

Thus, in accordance with one embodiment of the present invention, the processor-based device 120 is capable of receiving data acquired by the acoustic detectors 215, 222 and data associated with the audio profiles 225. The processor-based device 120 is also able to determine an acoustic signal or other acoustic data that may be provided by the audio presentation device 205 and/or the display device 207 using the data received from the acoustic detectors 215, 222 and the audio profile 225. In one embodiment, determining the acoustic signal that may be provided by the audio presentation device 205 using the data received from the acoustic detectors 215, 222 and the audio profile 225 includes determining a close caption corresponding to the acoustic signal.

In one embodiment, the processor-based device 120 may determine a signal-to-noise ratio using the data received from the acoustic detectors 215, 222. The signal-to-noise ratio may be representative of a broad acoustic spectrum or a specific frequency range, such as frequencies below and/or above 440 Hz. If the determined signal-to-noise ratio is below a predetermined threshold, the processor-based device 120 may determine an acoustic signal that may compensate, at least in part, for the low signal strength relative to the ambient noise. In one embodiment, the audio profiles 225 may contain data indicative of the predetermined signal-to-noise threshold.

Persons of ordinary skill in the art having benefit of the present disclosure will appreciate that the potential data acquired by the acoustic detector 215 and the possible contents of the audio profiles 225 may vary greatly depending on the application and context in which the present invention is practiced. It would therefore be difficult, or even impossible, to list all the types of data that may be received and all the features that may be entered into the audio profiles 225. Moreover, the possible acoustic signals determined by the processor-based device 120 using the data received from the acoustic detectors 215, 222 and the audio profiles 225 may also vary greatly and it would therefore be difficult, if not impossible, to enumerate all the possible acoustic signals. Accordingly, in the interest of clarity, the above discussion of the capabilities of the system 200 is limited to a few illustrative embodiments that are intended to be exemplary of the manner in which the present invention may be practiced. The aforementioned embodiments are not, however, intended to limit the present invention.

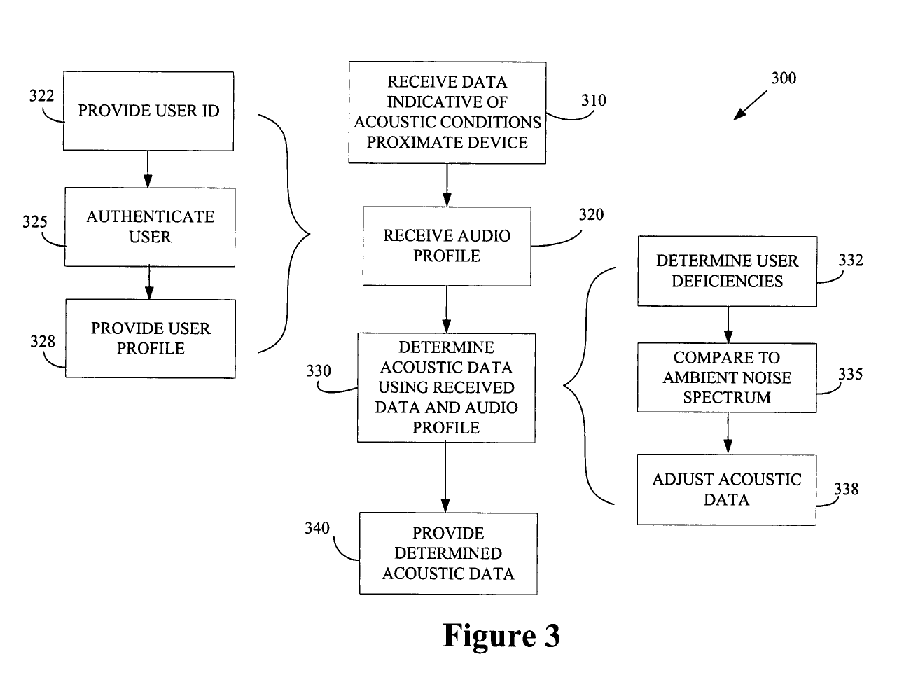

FIG. 3 conceptually illustrates one embodiment of a method 300 of providing audio presentations based upon environmental context and user preferences. In one embodiment, the processor-based device 120 receives (at 310) data indicative of acoustic conditions proximate to an audio presentation device, such as the audio presentation devices 115(1-4), 205 shown in FIGS. 1, 2, 3A, and 3B. For example, the processor-based device 120 may acquire (at 310) data collected by a microphone that may be deployed proximate to the audio presentation device. In one embodiment, the processor based device 120 may analyze the data indicative of the acoustic conditions to determine a spectrum of the ambient noise.

The processor-based device 120 also receives (at 320) at least one audio profile, such as the audio profiles 225 shown in FIG. 2. In one embodiment, the processor-based device 120 receives (at 320) the audio profiles by accessing an audio profile database, such as the audio profile database 230 shown in FIG. 2. In one embodiment, the audio profile database is stored on a remote server (not shown) and may be accessed by providing (at 322) a user identification number or other indications of the user, such as a name, a username or alias, a password, and the like. For example, a federated identification number, such as may be included in a Microsoft Passport®, associated with the user may be used to access the audio profile stored on a federated server. The user is then authenticated (at 325) using the user identification and a user profile is provided (at 328) to the processor based device 120 by the remote server.

The processor-based device 120 then determines (at 330) acoustic data that may be provided by the audio presentation device using the received data and the received audio profile. In one embodiment, the processor based device 120 determines (at 332) one or more deficiencies in the user's hearing using the user profile. For example, the processor-based device 120 may determine (at 332) that the user has a hearing deficiency at frequencies above 440 hertz. The processor-based device 120 may then compare (at 335) the determined deficiencies to the ambient noise spectrum and then adjust (at 338) the acoustic data accordingly. For example, if the ambient noise is present at frequencies above 440 hertz, where the user has a hearing deficiency, the processor-based device may adjust (at 338) the acoustic data to shift the acoustic signal to frequencies below 440 hertz. In alternative embodiments, the determined acoustic data may include corresponding close captioning or other representations of sound.

In one embodiment, the processor-based device 120 then provides (at 340) a signal indicative of the determined acoustic data to the audio presentation device. For example, the processor-based device 120 may determine (at 330) that an acoustic signal enhanced at frequencies below 440 Hz should be provided by the audio presentation device. For another example, the processor-based device 120 may determine (at 330) that a close caption corresponding to the acoustic data should be provided by the display device. Thus, the processor-based device 120 may provide (at 340) a signal, such as an electric signal, indicative of the determined acoustic data to the audio presentation device and/or the display device, which may use the provided signal to provide the determined acoustic data.

As noted earlier, in one embodiment, the device 120 may be located remotely from the audio presentation device. The device 120 may, for example, be a server or a proxy server. In such an embodiment, the remotely located device 120 may perform one or more of the acts described in FIG. 3, including determining (at 330) the acoustic data, and then providing (at 340) a signal indicative of the determined acoustic data to the audio presentation device. The acoustic data may be determined (at 330) based on at least a portion of the acoustic condition(s) and at least a portion of the audio profile that are accessible (or provided) to the remotely located device 120.

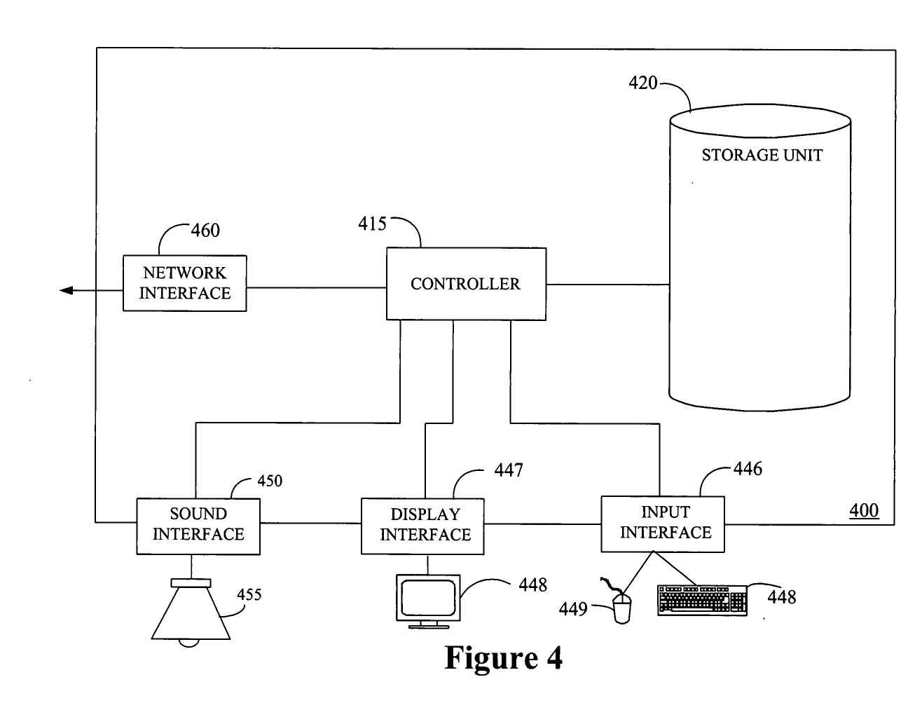

FIG. 4 shows a stylized block diagram of a processor-based system 400 that may be implemented in the system 100 shown in FIG. 1, in accordance with one embodiment of the present invention. In one embodiment, the processor-based system 400 may represent portions of one or more of the devices 110(1-4) and/or the processor-based device 120 of FIG. 1, with the system 400 being configured with the appropriate software configuration or configured with the appropriate modules 140, 150 of FIG. 1.

The system 400 comprises a control unit 410, which in one embodiment may be a processor that is communicatively coupled a storage unit 420. The software installed in the storage unit 420 may depend on the features to be performed by the system 400. For example, if the system 400 represents one of the devices 110(1-4), then the storage unit 420 may include the remote module 140. The modules 140, 150 may be executable by the control unit 410. Although not shown, it should be appreciated that in one embodiment an operating system, such as Windows®, Disk Operating Systems, Unix®, OS/2®, Linux®, MAC OS®, or the like, may be stored on the storage unit 420 and be executable by the control unit 410. The storage unit 420 may also include device drivers for the various hardware components of the system 400.

In the illustrated embodiment, the system 400 includes a display interface 430. The system 400 may display information on a display device 435 via the display interface 430. In the illustrated embodiment, a user may input information using an input device, such as a keyboard 440 and/or a mouse 445, through an input interface 450. In the illustrated embodiment, the system 400 includes a sound interface 450 that may be used to provide an acoustic signal to an audio presentation device 455, such as the audio presentation devices, 115(1-4), 205, 222. Although not shown in FIG. 5, the system 400 may also include a detector, such as the acoustic detector 210 shown in FIG. 2.

The control unit 410 is coupled to a network interface 460, which may be adapted to receive, for example, a local area network card. In an alternative embodiment, the network interface 460 may be a Universal Serial Bus interface or an interface for wireless communications. The system 400 communicates with other devices through the network interface 460. For example, the control unit 410 may receive one or more audio profiles 225 from a audio profile database 230 stored in a remote storage medium (not shown) via the interface 460. Although not shown, associated with the network interface 460 may be a network protocol stack, with one example being a UDP/IP (User Datagram Protocol/Internet Protocol) stack or Transmission Control Protocol/Internet Protocol. In one embodiment, both inbound and outbound packets may be passed through the network interface 460 and the network protocol stack.

It should be appreciated that the block diagram of the system 400 of FIG. 4 is exemplary in nature and that in alternative embodiments, additional, fewer, or different components may be employed without deviating from the spirit and scope of the instant invention. For example, if the system 400 is a computer, it may include additional components such as a north bridge and a south bridge. In other embodiments, the various elements of the system 400 may be interconnected using various buses and controllers. Similarly, depending on the implementation, the system 400 may be constructed with other desirable variations without deviating from the spirit and scope of the present invention.

The various system layers, routines, or modules may be executable control units, such as the control unit 410. The control unit 410 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 415 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. An method, comprising:
receiving data indicative of acoustic conditions proximate to an audio presentation device;
receiving data associated with at least one audio profile; and
determining acoustic data to be provided based on at least a portion of the received data indicative of acoustic conditions proximate to the audio presentation device and at least a portion of the data associated with the at least one audio profile.

2. The method of claim 1, wherein determining the acoustic data comprises determining a close caption corresponding to an acoustic signal.

3. The method of claim 1, wherein receiving the data indicative of acoustic conditions proximate to the audio presentation device comprises receiving the data from at least one acoustic detector deployed proximate to the audio presentation device.

4. The method of claim 3, wherein receiving the data indicative of acoustic conditions proximate to the audio presentation device comprises providing an acoustic test signal.

5. The method of claim 4, wherein receiving the data indicative of acoustic conditions proximate to the audio presentation device comprises receiving a portion of the acoustic test signal from the acoustic detector.

6. The method of claim 5, wherein receiving the data indicative of acoustic conditions proximate to the audio presentation device comprises receiving an acoustic noise signal from the acoustic detector.

7. The method of claim 6, wherein determining the acoustic data to be provided comprises determining a signal-to-noise ratio using the received portion of the acoustic test signal and the received acoustic noise signal.

8. The method of claim 7, wherein receiving the audio profile comprises receiving an indication of at least one deficiency in the hearing of a user.

9. The method of claim 8, wherein determining the acoustic data to be provided comprises comparing the indication of at least one deficiency in the hearing of the user to the determined signal-to-noise ratio.

10. The method of claim 1, further comprising determining that a new user is using the audio presentation device, and wherein receiving the audio profile comprises receiving the audio profile in response to determining that the new user is using the audio presentation device.

11. The method of claim 1, wherein receiving the audio profile comprises receiving at least one of a user profile and a device profile, and wherein receiving the audio profile comprises receiving at least one of a Composite Capabilities/Preferences Profile and a Learner Profile.

12. The method of claim 1, wherein determining the acoustic data comprises:
determining the acoustic data using a processor-based device located remotely from the audio presentation device; and
providing the acoustic data from the processor-based device to the audio presentation device.

13. An apparatus, comprising:
an interface; and
a control unit coupled to the interface and adapted to:
receive data indicative of acoustic conditions proximate to an audio presentation device;
receive data associated with at least one audio profile; and
determine acoustic data to be provided based on at least a portion of the received data indicative of acoustic conditions proximate to the audio presentation device and at least a portion of the data associated with the at least one audio profile.

14. The apparatus of claim 13, further comprising a display device, and wherein the control unit is adapted to determine a close caption to be provided by the display device based on at least the portion of the received data indicative of acoustic conditions proximate to the audio presentation device and the portion of the data associated with the at least one audio profile.

15. The apparatus of claim 13, wherein the at least one audio presentation device is adapted to provide the determined acoustic data as an acoustic signal.

16. The apparatus of claim 15, wherein the control unit coupled to the interface is adapted to provide a signal indicative of the determined acoustic data to the audio presentation device.

17. The apparatus of claim 13, wherein the audio presentation device is at least one of a personal data assistant, a laptop computer, a desktop computer, a cellular telephone, a global positioning system, an automobile navigation system, a projection device, a radio, an MP3 player, and a television.

18. The apparatus of claim 13, further comprising at least one detector for acquiring the data indicative of acoustic conditions proximate to the at least one audio presentation device.

19. The apparatus of claim 18, wherein the at least one audio presentation device comprises at least one audio presentation device adapted to provide an acoustic test signal, and wherein the at least one detector is adapted to receive a portion of the acoustic test signal, and wherein the at least one detector is adapted to receive a portion of an acoustic noise signal.

20. The apparatus of claim 19, wherein the control unit is adapted to receive a signal indicative of a portion of the received test noise signal and a portion of the received acoustic noise signal from the acoustic detector.

21. The apparatus of claim 20, wherein the control unit is adapted to determine a signal-to-noise ratio using the signal indicative of the received portion of the acoustic test signal and the received acoustic noise signal.

22. The apparatus of claim 21, wherein the control unit is adapted to determine that a user has at least one hearing deficiency.

23. The apparatus of claim 22, wherein the control unit is adapted to determine the acoustic data to be provided by comparing the user's hearing deficiency to the signal-to-noise ratio.

24. The apparatus of claim 13, further comprising at least one storage device for storing at least one audio profile database containing the at least one audio profile, and wherein the storage device is at least one of a local storage medium coupled to the control unit and a remote storage medium coupled to the interface.

25. An apparatus, comprising:
means for receiving data indicative of acoustic conditions proximate to an audio presentation device;
means for receiving data associated with at least one audio profile; and
means for determining acoustic data to be provided based on at least a portion of the received data indicative of acoustic conditions proximate to the audio presentation device and at least a portion of the data associated with the at least one audio profile.

26. A system, comprising:
at least one audio presentation device;
at least one storage device adapted to store at least one audio profile;
at least one detector for acquiring data indicative of acoustic conditions proximate to the at least one audio presentation device; and
a processor-based device adapted to:
receive the data indicative of acoustic conditions proximate to the audio presentation device;
receive data associated with at least one audio profile; and
determine acoustic data to be based on at least a portion of the received data indicative of acoustic conditions proximate to the audio presentation device and at least a portion of the data associated with the at least one audio profile.

27. The system of claim 26, further comprising at least one display device, and wherein the processor-based device is adapted to determine a close caption corresponding to the acoustic data to be displayed on the display device

28. The system of claim 26, wherein the audio presentation device is at least one of a personal data assistant, a laptop computer, a desktop computer, a cellular telephone, a global positioning system, an automobile navigation system, a projection device, a radio, an MP3 player, and a television.

29. A computer program product in a computer readable medium which when executed by a processor performs the steps comprising:
receiving the data indicative of acoustic conditions proximate to the audio presentation device;
receiving data associated with at least one audio profile; and
determining acoustic data to be based on at least a portion of the received data indicative of acoustic conditions proximate to the audio presentation device and at least a portion of the data associated with the at least one audio profile.

30. The product of claim 29, wherein the computer program product when executed by the processor performs the steps comprising providing an acoustic test signal.

31. The product of claim 30, wherein the computer program product when executed by the processor performs the steps comprising receiving a portion of the acoustic test signal from an acoustic detector.

32. The product of claim 31, wherein the computer program product when executed by the processor performs the steps comprising receiving an acoustic noise signal from the acoustic detector.

33. The product of claim 32, wherein the computer program product when executed by the processor performs the steps comprising determining a signal-to-noise ratio using the received portion of the acoustic test signal and the received acoustic noise signal.

34. The product of claim 33, wherein the computer program product when executed by the processor performs the steps comprising receiving an indication of at least one deficiency in hearing of a user.

35. The product of claim 34, wherein the computer program product when executed by the processor performs the steps comprising comparing the indication of at least one deficiency in the hearing of the user to the determined signal-to-noise ratio.
